(19) United States
(12) Patent Application Publication
(10) Pub. No.: US 2021/0030616 A1
(43) Pub. Date: Feb. 4, 2021

(54) Device and Method for Treatment of Newborn Babies for Autism

(71) Applicant: Monty L. Ruetenik, Clear Lake Shores, TX (US)

(72) Inventor: Monty L. Ruetenik, Clear Lake Shores, TX (US)

(21) Appl. No.: 16/846,751

(22) Filed: Apr. 13, 2020

Related U.S. Application Data
(60) Provisional application No. 62/880,190, filed on Jul. 30, 2019.

(51) Int. Cl. A61H 9/00

(52) U.S. Cl. CPC A61H 9/0071; A61H 2203/03

(57) ABSTRACT

A device and method for the treatment of newborn babies and more specifically a strap system with pressure bags to provide pressure to the bodies of newborns. The device is designed to simulate natural birth that applies pressure to a birthing infant to trigger cessation of neurosteriods that is simple to use, effective and reliable.

### FIELD

This invention relates to a device and method for the treatment of newborn babies and more specifically to a strap system with pressure bags to provide pressure to the bodies of newborns. The device is designed to simulate natural birth that applies pressure to a birthing infant to trigger cessation of neurosteriods that is simple to use, effective and reliable.

### BACKAROUND

Veterinary researchers at University of California, Davis have discovered that newborn foals that exhibit neonatal maladjustment syndrome (sometimes called Dummy Foal syndrome) can be treated by applying body-surrounding pressure to the foal's body after birth to simulate the squeeze of a normal birth. Foals that have a rapid and easy birth as well as those having cesarean section birth are much more likely to exhibit the syndrome. It is believed that the pressure triggers the cessation of neurosteroids that are produced in babies to reduce the pain of birth. The similarity of a dummy foal symptoms are markedly similar to some of the symptoms of newborn infants that develop autism. In a report by University of California, Davis researchers on the work on Dummy foal syndrome it is said, in part, “The researchers suspect that the pressure triggers biochemical changes in the central nervous system that are critical for transitioning the foal from a sleeplike state in the womb to wakefulness at birth. . . it appears that the rope restraint provides strong tactile stimulation, similar to what the foal should experience during labor and passage through the birth canal,” he said. Using brain-wave studies conducted by Monica Aleman, the researchers have confirmed that the foals truly go into slow-wave sleep with the squeeze procedure, and endocrine changes also occur with the squeeze. ‘“We have the unique ability to obtain brain wave data to determine the nature of some of the brain changes with the neurosteroids in the neonatal horse,’” Aleman said. The procedure mirrors ‘“kangaroo care’” for human babies Madigan says the findings are not without precedent in human medicine, citing anecdotal evidence that tactile pressure appears to also be important for infants. In the second' stage of labor, an important signal tells the foal to quit producing the sedative neurosteroids and “wake up.’” ‘“There are reports of very sick newborn babies, determined unlikely to survive, making seemingly miraculous, spontaneous recoveries after being placed in the arms of a grieving parent for a last embrace,’” Madigan said. Perhaps those babies benefited from some form of squeeze-induced stimulation or neuroactivation ‘“similar to what we are seeing in the foals.’” He noted that many hospitals are making newborn ‘“kangaroo care’”, ‘“immediate skin-to-skin contact with the mother as well as swaddling in a light blanket’” a standard procedures right after birth. Premature infant survival is dramatically improved when kangaroo care is implemented, he said. Baby feels like it's in the womb ‘“Kangaroo care makes babies feel like they are in the womb,’” said Mark Underwood, chief of pediatric neonatology at the UC Davis Children's Hospital. ‘“In newborn babies that have received kangaroo care, we see their heart rates stabilize, their sleep deepen and agitation decrease.’”. . . ‘“We do know, however, that in babies, labor brings interesting changes in steroid levels.’” Madigan adds that earlier medical studies that have found concentrations of neurosteroids, similar to those found in neonatal foals, are present after birth and then rapidly decline in both full-term and early-term human babies. However after 12 hours, the preterm infants have significantly higher levels of those neurosteroids than do the full-term infants, mirroring what is seen in foals with the maladjustment syndrome . . . . Autism, or autism spectrum disorder, refers to a group of complex brain-development disorders . . . . When Madigan decided to examine possible links between the foal disorder and childhood autism, he approached Pessah with videos of foals affected by the maladjustment syndrome. Foal behaviors resemble autism ‘“There are thousands of potential causes for autism, but the one thing that all autistic children have in common is that they are detached.’” Bailey; Newborn Horses Give Clues to Autism Newborn Horses Give Clues to Autism; Feb. 3, 2015 in Human & Animal Health Newborn Horse Syndrome Suggests Links to Childhood Autism .

### BRIEF DESCRIPTION OF THE DRAWINGS

FIG. 1 is a side view of an embodiment of a strap system of the invention.

FIG. 1A is perspective view of an embodiment of the invention showing a body-surrounding strap and location of pressure bags.

FIG. 2 is a top view of a strap of an embodiment of the invention.

FIG. 3 is a top view of a bottom layer of a strap of an embodiment of the invention showing placement of inflatable bags and connector elements.

FIG. 4 is an end view of the embodiment of FIG. 3, enlarged and not to scale.

FIG. 5 is another top view of a bottom layer of an embodiment of a strap of the invention showing placement of a sectioned inflatable structure and connector elements.

FIG. 6 is a top view of a bottom layer of an embodiment of a strap of the invention showing placement of a surrounding fabric blanket.

FIG. 7 is an end view of the embodiment of FIG. 6, enlarged and not to scale.

FIG. 7A is a schematic representation of an embodiment of the invention showing arrangement of pressure control elements.

FIG. 7B is a schematic representation of another embodiment of the invention showing arrangement of pressure control elements.

### DETAILED DESCRIPTION

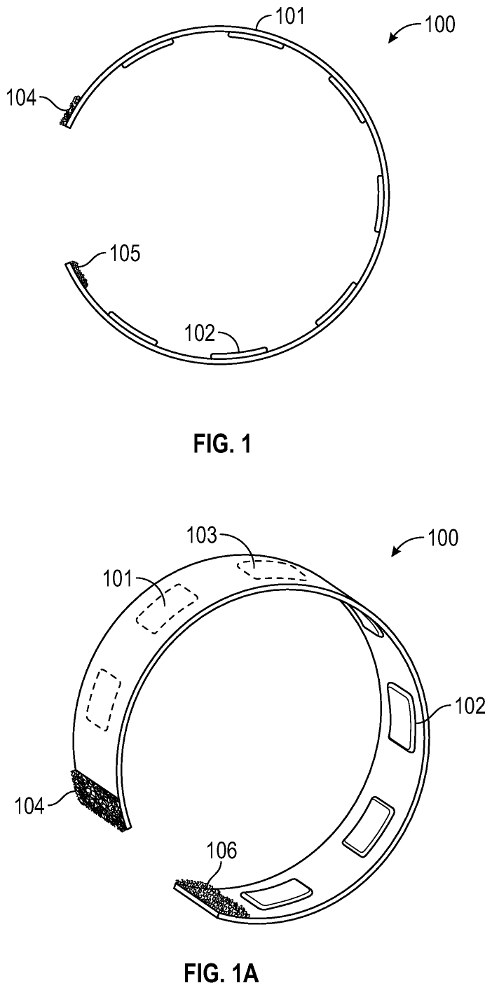

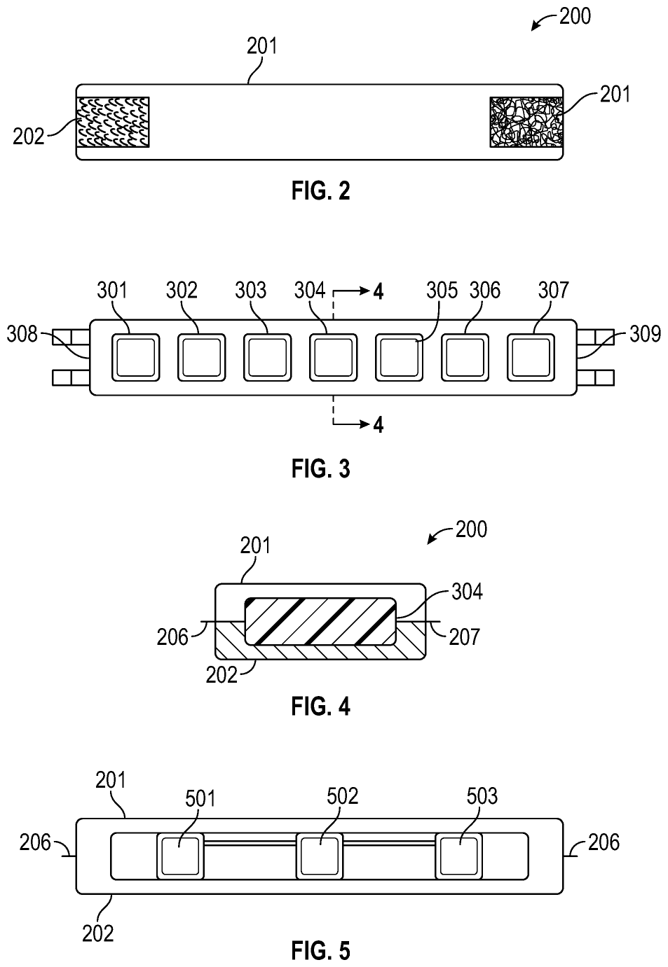

The invention is a device for use on newborn infants that have been born by caesarian section or that has experienced a rapid and easy birth and thus, are a candidate for developing autism. The device consists of connected layered body-surrounding fabric straps sized to surround an newborn infant's body between the underarms and hips. The straps have disposed on them a series of or a strip of inflatable bags that are attached by conduit to each other and to inflator (pressure) means (hand air bulb pump or electric pump). A 1-6 inch wide webbing strap of non-rubbing seatbelt weave is very suitable. Such fabric is very soft and flexible. In general, the strap will be of significant length to surround an infant's body with sufficient additional length to fasten the ends together. A 18 to 32 inch length will generally be suitable. As shown in FIG. 1 (a simplified schematic of the connected layered straps) there is a surrounding strap 101, having an adjustable closure 106 (described in more detail below) and having a series of inflatable bags, 101,102 and 103. The closure 104 and 105 illustrated is one-half of hook and loop fastener strips are attached (described below). FIG. 1A is a perspective view of the same and FIG. 2 is a top view showing placement of optional hook and loop straps, 201 and 202, one on top side and the other on the bottom side. The strap 200 may, in the alternative, be secured around a infant's body by buckles, or slip straps or any other suitable means that will allow the fabric strap to be adjustably connects to form a secure enclosing circumference around an infant's body. The structures 100 and 200 comprise two layers, 201 and 202 as shown in FIG. 4. They may be the same or different fabric. Items 206 and 207 illustrate a seam connecting the layers. In FIG. 4 is a section AA view of FIGS. 3 and 304 is the same as 304 in FIG. 3. FIG. 3 is the top side of the bottom layer of 200 showing placement of inflatable bags 301, 302, 303, 304, 305, 306 and 307. Items 308 and 309 are connection straps with buckle or slip buckles. FIG. 5 illustrates another embodiment wherein the inflatable bags are replaced by a single inflatable structure with partitions, 501, 502 and 503, to form a kind of bag structure singular to that of FIG. 3. The sections of the bags are interconnected by conduit.

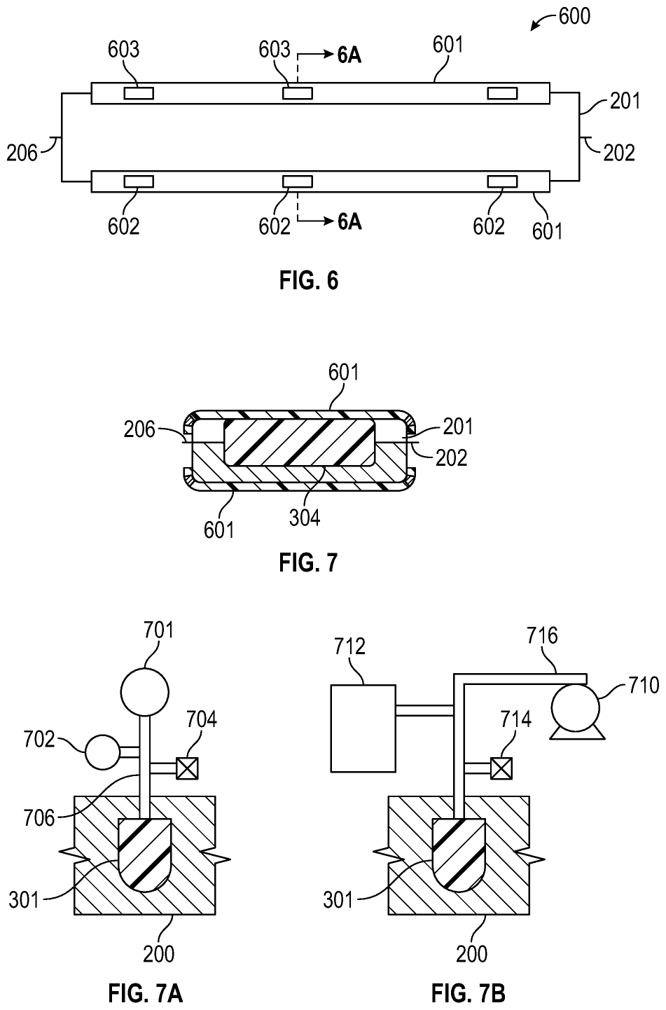

FIG. 6 illustrates an embodiment wherein there is attached to the inside, 202, (bottom side that will be next to the infant) of a softer blanket or other fabric material, 601. It is removably attached, 602, to the bottom of the s strap 200 with edges folded over to be connected to the top side 201. FIG. 6A shows a section BB view of FIG. 6.

The strip of hook and loop fasteners shown in FIG. 1 and 1A may be attached directly to the inside surface of the surrounding strap or disposed on a soft fabric pad (as shown). The hook and loop strips may be multiple strips or an elongated strip to facilitate arranging the bags to a preferred location. In preferred embodiments, the inflatable bags are removably attached to a strip of hook and loop material attached to the body-surrounding strap and matching hook and loop strip attached to the bags. They may, however be permanently attached as by adhesive or stitching.

The bag or bags are connected to a pressuring source that may be a hand squeeze bulb, 701 of FIG. 7A, (preferred) or a hand or electric compressor to supply air to inflate the bags. A relief valve, 704, is provided to de-inflate the bags. Referring to FIG. 7A and 7B, there is a pressure source 701 with as relief valve 704 connected by conduit 706 to inflatable bag or bags 301 (or in series or parallel to multiple bags) and a pressure gauge 702. In FIG. 7B the pressure source 710 is a pressure pump or pressure reservoir connected conduit 716 to a recorder controller 712. There is a relief valve 714. The relief valves can be set to ensure that too high pressure is not inadvertently applied (such as for example to relieve at 15 psi). It may also be useful to provide a recording and controller on the system to record the time and pressure of a treatment as illustrated by 712 in FIG. 7B. This can be accomplished by an in-place pressure recorder of a sensor and transmitter to a remote recording device. The recording may be hard wired to the system or remotely connected as by a sensor and Bluetooth transmitter. In general, the pressure needs to be about 15 psi or less to obtain the necessary inflation. Generally, about 4- 8 psi pressure and preferable about 6 psi of pressure on the sides of the infant is believed sufficient. As shown in the figures there are three sets of bags on each side of the surrounding fabric strap 200 and one on the bottom. This will provide pressure to the sides and back of the infant. While the arrangement as shown is deemed sufficient and preferred, there may be more or less bags and they may be sized differently. For example, there may be only one bag on each side that is longer and that has one or more strips of hook and loop fastener. This arrangement is designed to simulate the squeeze of birthing described in the Background above and to simulate the time in the birth canal during a normal birth. In general, the pressure will be applied for about 15 to 30 minutes (10 minutes generally preferred) and is desirably accomplished on newborn infant within the first 10 hours after birth. “Newborn” as the term is used herein means within about 24 hours after birth. Thus, it is important that the device be easily usable at the site of birthing and not just in a clinical setting. Thus, the device may be used in a home setting and by mid-wives. A delay could be fatal. More than one treatment (application and inflation of the bags) may be required. The timing and nature of the treatment is easily determined by trial and error.

The ends of the surrounding strap device will have adjustable connectors that allow the strap to be tightened around the infant's body. There may also be provided a spreader bar to evenly spread the load of the surrounding strap for uniform loading. “Tightening” as the term is used herein, mean to pull the strap around the infant's body so that it is in substantial contact withal surface of the body under the strap.

The a pressure source is arranged on the strap so as to be on the top or back of the infant for connivance and easy access.

In use the straps are placed around the infant's body and pressure applied to the desired or predetermined level. The pressure remains for a predetermined time and released. The infant may show signs of response (waking, more alertness, crying, etc.). If not additional treatment may be applied.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. A device for treating newborn infants comprising:
a. two connected layered fabric straps having a top and bottom sized to be removable fitted and tightened around the body of a new born equine foal, said straps having disposed on the bottom surface an inflatable pressure bag or bags,
b. connection means to a pressure source, and
c. means to apply pressure to the bags to inflate them, the pressure mean being connected to the pressure bags by a conduit;

2. The device of claim 1 wherein the connection means b. is hook and loop fasteners, with one side of the fastener attached to the end of the layer fabric satrap and the other to the opposite end.

3. The device of claim 1 wherein the inflatable bag or bag are connected to the layer fabric strap by hook and loop fasteners.

4. The device of claim 1 wherein the straps in made of webbed fabric and is about 2 to 6 inches in width.

5. The device of claim 1 wherein there is also means for removable blanket to be attached to the bottom strap.

6. The device of claim 1 wherein there is pressure means for pressuring the bags comprising a squeeze bulb or electric pressure pump.

7. The device of claim 1 wherein there is also provided means for recording the pressure applied by the pressure and the duration of the pressure at each level.

8. A method of treating newborn infants comprising applying to the body a newborn foal a device comprising;
a. connected layered fabric straps sized to be removable fitted and tightened around the body of a new born infant having disposed on the inside surface of one the strap inflatable pressure bag or bags, connection means to a pressure source, and
b. means to apply pressure to the bags to inflate them, the pressure mean being connected to the pressure bags by a conduit;
c. tightening the device around the infant's body and inflating the bags therein to about 4 to 8 pounds pressure;
d. continuing to apply the pressure for 5 to 30 minutes and then releasing the pressure and removing the device.

9. The method of claim 8 wherein the bag or bag are connected to the layer fabric strap by hook and loop fasteners 2 to 6 inches in width.

11. The method of claim 8 wherein there is also means for removable blanket to be attached to the bottom strap.

10. An assembly for treating newborn infants comprising;
a. connected layered fabric straps sized to be removable fitted and tightened around the body of an infant having disposed on the inside surface of one the strap inflatable pressure bag or bags, connection means to a pressure source, and
b. means to apply pressure to the bags to inflate them, the pressure mean being connected to the pressure bags by a conduit;
c. tightening the device around the infant's body and inflating the bags therein to about 4 to 8 pounds pressure;
d. continuing to apply the pressure for 5 to 30 minutes and then releasing the pressure and removing the device;
e. and means to record the pressure applied.
